(19) United States
(12) Patent Application Publication
(10) Pub. No.: US 2001/0006224 A1
(43) Pub. Date: Jul. 5, 2001

(54) Slurry for chemical mechanical polishing

(76) Inventors: Yasuaki Tsuchiya, Tokyo (JP); Tomoko Wake, Tokyo (JP); Tetsuyuki Itakura, Tokyo (JP); Shin Sakurai, Tokyo (JP); Kenichi Aoyagi, Tokyo (JP)

Correspondence Address: Paul J. Esatto, Jr., Scully, Scott, Murphy & Presser, 400 Garden City Plaza, Garden City, NY, 11530, US

(21) Appl. No.: 09/741,408

(22) Filed: Dec. 20, 2000

(30) Foreign Application Priority Data
Dec. 28, 1999 (JP) 374486/1999

(51) Int. Cl. C09K 5/00

(52) U.S. Cl. 252/79

(57) ABSTRACT

In chemical mechanical polishing of a substrate comprising a tantalum-containing metal film, a slurry for chemical mechanical polishing comprising a silica polishing grain and an inorganic salt in an amount of 0.01 wt % to 10 wt % both inclusive may be used to prevent dishing and erosion, as well as to achieve an improved polishing rate for tantalum without any damage to tantalum.

### BACKGROUND OF THE INVENTION

This invention relates to a slurry for chemical mechanical polishing used in manufacturing a semiconductor device. In particular, it relates to a slurry for chemical mechanical polishing suitable for forming a damascene metal interconnect where a tantalum-containing metal is used as a barrier metal film material.

With regard to forming a semiconductor integrated circuit such as ULSI which has been significantly refined and compacted, copper has been expected to be a useful material for electric connection because of its good electromigration resistance and lower electrical resistance.

To date a copper interconnect is formed as follows due to problems such as difficulty in patterning by dry etching. Specifically, a concave such as a trench and a connection hole is formed in an insulating film, a barrier metal film is formed on the surface, a copper film is deposited by plating such that the concave is filled with the material, and then the surface is polished to be flat by chemical mechanical polishing (hereinafter, referred to as “CMP”) until the surface of the insulating film except the concave area is completely exposed, to form electric connections such as a damascene connection interconnect in which the concave is filled with copper, a via plug and a contact plug.

There will be described a process for forming a damascene copper interconnect with reference to FIG. 1.

On a silicon substrate on which a semiconductor device is formed (not shown), is formed a lower interconnect layer 1 made of an insulating film comprising a lower interconnect (not shown). Then, as shown in FIG. 1(a) are sequentially formed a silicon nitride film 2 and a silicon oxide film 3. On the silicon oxide film 3 is formed a concave having an interconnect pattern and reaching the silicon nitride film 2.

Then, as shown in FIG. 1(b), a barrier metal film 4 is formed by sputtering. On the film is formed a copper film 5 over the whole surface by plating such that the concave is filled with the material.

As shown in FIG. 1(c), the copper film 5 is polished by CMP to make the substrate surface flat. Polishing by CMP is continued until the metal over the silicon oxide film 3 is completely removed, as shown in FIG. 1(d).

In the above process for forming a damascene copper interconnect, a barrier metal film is formed as a base film for, e.g., preventing diffusion of copper into the insulating film. However, when using a tantalum-containing metal such as Ta and TaN as a barrier metal film, there is a problem that a polishing rate for the barrier metal film made of Ta or TaN is significantly smaller than that for the copper film using a conventional polishing slurry due to extreme chemical stability of Ta and TaN. Specifically, when forming, e.g., a damascene copper interconnect by CMP using a conventional polishing slurry, there is a significant difference between the polishing rates for the copper film and the barrier metal film, which may cause dishing and erosion.

Dishing is a phenomenon that copper in the concave is excessively polished so that the center of the copper film in the concave is depressed in relation to the plane of the insulating film on the substrate, as shown in FIG. 2. A conventional polishing slurry requires an adequately much polishing time for completely removing the barrier metal film 4 on the insulating film (silicon oxide film 3) because of a considerably lower polishing rate for the barrier metal film. The polishing rate for the copper film 5 is extremely higher than that for the barrier metal film 4, so that the copper film 5 is excessively polished, resulting in dishing.

Erosion is a phenomenon that polishing in a dense interconnect area excessively proceeds in relation to that in a sparse area such as an isolated interconnect area so that the surface of the dense interconnect area becomes depressed in relation to the other surfaces, as shown in FIG. 1(d). When the dense interconnect area comprising many damascenes in the copper film 5 is considerably separated from the isolated interconnect area comprising less damascenes in the copper film 5 by, for example, an area without interconnects within the wafer, and the copper film 5 is polished faster than the barrier metal film 4 or a silicon oxide film 3 (the insulating film), then a polishing pad pressure to the barrier metal film 4 or the silicon oxide film 3 in the dense interconnect area becomes higher than that in the isolated interconnect area. As a result, in the CMP process after exposing the barrier metal film 4 (the process of FIG. 1(c) and thereafter), there generates a difference in a polishing rate by CMP between the dense interconnect area and the isolated interconnect area, so that the insulating film in the dense interconnect area is excessively polished, resulting in erosion.

Dishing in the process for forming an electric connection part in a semiconductor device as described above, may cause increase in an interconnection resistance and a connection resistance, and tends to cause electromigration, leading to poor reliability in the device. Erosion may adversely affect flatness in the substrate surface, which becomes more prominent in a multilayer structure, causing problems such as increase and dispersion in an interconnect resistance.

JP-A 8-83780 has described that dishing in a CMP process may be prevented by using a polishing slurry containing benzotriazole or its derivative and forming a protective film on a copper surface. JP-A 11-238709 has also described that a triazole compound is effective for preventing dishing. The technique, however, controls dishing by reducing a polishing rate for a copper film. Thus, a difference in a polishing rate between a copper film and a barrier metal film may be reduced, but polishing of the copper film takes a longer time, leading to a lower throughput.

JP-A 10-44047 has described in its Examples that CMP may be conducted using a polishing slurry containing an alumina polishing grain, ammonium persulfate (an oxidizing agent) and a particular carboxylic acid to increase a difference in a polishing rate between an aluminum layer for interconnection and a silicon oxide film and to increase a removal rate for a titanium film as a barrier metal film. The technique in the Examples cannot, however, solve the above problems in forming a copper interconnect using a tantalum metal in a barrier metal film.

JP-A 10-46140 has described a polishing composition comprising a particular carboxylic acid, an oxidizing agent and water whose pH is adjusted by an alkali to 5 to 9. Examples in the publication have disclosed that a higher polishing rate for copper or aluminum can be achieved by using malic acid and furthermore adding silicon oxide as a polishing material to this polishing composition. There are, however, no description about polishing for a tantalum metal.

JP-A 10-163141 has disclosed a polishing composition for a copper film containing a polishing material and water, further comprising an iron (III) compound dissolved in the composition. Examples in the publication has described that a polishing rate for a copper film may be improved and surface defects such as dishing and scratches may be prevented, by using colloidal silica as a polishing material and iron (III) citrate, ammonium iron (III) citrate or ammonium iron (III) oxalate as an iron (III) compound. This publication, however, also has no descriptions about polishing for a tantalum metal.

JP-A 11-21546 has disclosed a slurry for chemical mechanical polishing comprising urea, a polishing material, an oxidizing agent, a film-forming agent and a complex-forming agent. Examples in this publication have described polishing Cu, Ta and PTEOS using a slurry having pH 7.5 prepared using alumina as a polishing material, hydrogen peroxide as an oxidizing agent, benzotriazole as a film-forming agent and tartaric acid or ammonium oxalate as a complex-forming agent. However, in the results shown in Table 6 therein, there is a significant difference in a removing rate between Cu and Ta. Furthermore, the publication has described only that addition of the complex-forming agent such as tartaric acid and ammonium oxalate is effective for disturbing a passive layer formed by a film-forming agent such as benzotriazole and for limiting a depth of an oxidizing layer. There are no descriptions about polishing for a tantalum metal film.

### SUMMARY OF THE INVENTION

An objective of this invention is to provide a slurry for chemical mechanical polishing, which can prevent dishing and erosion in polishing a substrate in which a tantalum metal film is formed on an insulating film and can allow us to form a reliable damascene electric connection part with good electric properties with a higher polishing rate.

To achieve the above objective, this invention provides a slurry for chemical mechanical polishing for polishing a substrate comprising an insulating film and a tantalum-containing metal film on the insulating film, comprising a silica polishing grain, and an inorganic salt in an amount of 0.01 wt % to 10 wt % both inclusive to a total amount of the slurry for chemical mechanical polishing.

In CMP of a substrate in which a tantalum-containing metal film is formed on an insulating film, a slurry for polishing of this invention may be used to form a reliable damascene electric connection part with good electric properties with a higher polishing rate, i.e., with a higher throughput, while preventing dishing and erosion.

### BRIEF DESCRIPTION OF THE DRAWINGS

FIG. 1 is a process cross section illustrating a process for forming a damascene copper interconnect according to the prior art.

FIG. 2 shows a cross section of an interconnect when forming a copper interconnect using a slurry for chemical mechanical polishing according to the prior art.

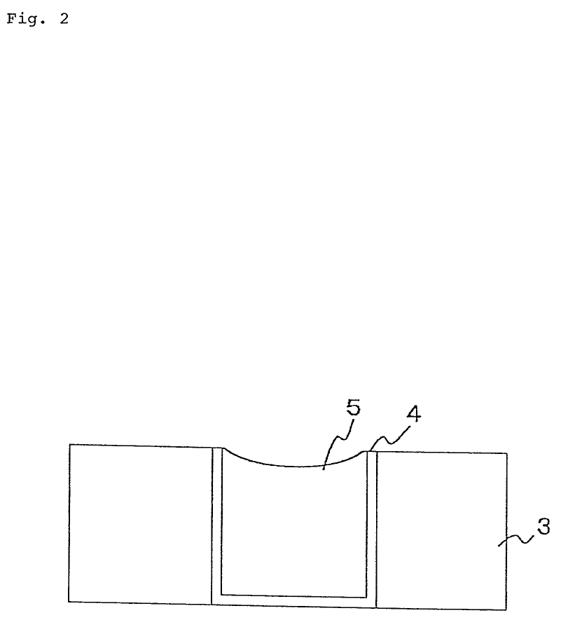

### DETAILED DESCRIPTION

Preferred embodiments of this invention will be described.

A slurry for chemical mechanical polishing (hereinafter, referred to as “a polishing slurry”) is suitable for polishing a tantalum-containing metal film such as tantalum (Ta) or tantalum nitride (TaN) formed on an insulating film. In particular, it can be suitably used in a process for forming an electric connection part such as a damascene interconnect comprising a tantalum metal film as a barrier metal film, a via plug and a contact plug, by CMP of a substrate where a tantalum metal film as a barrier metal film is formed on an insulating film having a concave and a conductive metal film is formed on the tantalum metal film such that the concave is filled with the conductive metal. The polishing slurry of this invention may be used after polishing the conductive metal film and exposing the tantalum metal film in the CMP process.

CMP using a polishing slurry of this invention allows us to form a reliable damascene electric connection part with good electric properties with a higher polishing rate, i.e., with a higher throughput, while preventing dishing and erosion.

As a silica polishing grain contained in a polishing slurry of this invention, abrasions consisting of silicon dioxide may be used; for example, fumed silica and colloidal silica. A silica polishing grain may be prepared by a variety of known processes; for example, fumed silica by vapor phase synthesis via reaction of silicon tetrachloride in a flame of oxygen and hydrogen, and silica prepared by hydrolyzing a metal alkoxide in a liquid phase and then baking it.

In manufacturing a semiconductor device using a polishing slurry of this invention, among these polishing grains consisting of silicon oxide, fumed silica is preferable because of its lower price and substantial absence of Na as an impurity. If the polishing slurry contains Na, Na may easily react with Si frequently used in forming a substrate to adhere to and remain on the substrate, so that it becomes difficult to remove Na in a washing step after the CMP process.

An average diameter of the silica polishing grain is preferably at least 5 nm, more preferably at least 50 nm; and preferably 500 nm or less, more preferably 300 nm or less as determined by a light scattering diffraction technique. Regarding a diameter distribution, the maximum diameter (d100) is preferably 3 μm or less, more preferably 1 μm or less. A specific surface area is preferably at least 5 m²/g, more preferably at least 20 m²/g; and 1000 m²/g or less, more preferably 500 m²/g or less as determined by B.E.T.

The content of the silica polishing grain in the polishing slurry may be appropriately selected within the range of 0.1 to 50 wt % both inclusive to the total amount of the slurry composition in the light of factors such as a polishing efficiency and polishing accuracy. It is preferably at least 1 wt %, more preferably at least 2 wt %, further preferably at least 3 wt %; and preferably 30 wt % or less, more preferably 10 wt % or less, further preferably 8 wt % or less.

An inorganic salt used in a polishing slurry of this invention may be at least one selected from the group consisting of salts containing ammonium ion, salts containing alkali metal ion, salts containing alkali-earth metal ion, salts containing group IIIB metal ion, salts containing group IVB metal ion, salts containing group VB metal ion and salts containing transition metal ion.

Examples of an alkali metal ion include Li, Na, K, Rb, Cs and Fr ions. Examples of an alkali-earth metal ion include Be, Mg, Ca, Sr, Ba and Ra ions. Examples of a group IIIB metal ion include Al, Ga, In and Tl ions. Examples of a group IVB metal ion include Sn and Pb ions. An example of a group VB metal ion is Bi ion. Examples of a transition metal ion include lanthanide metal ions such as Sc, Ti, V, Cr, Mn, Fe, Co, Ni, Cu, Zn, Y, Zr, Nb, Mo, Tc, Ru, Rh, Pd, Ag, Cd and La ions, and actinoid metal ions such as Hf, Ta, W, Re, Os, Ir, Hg and Ac ions. An salt containing these is preferable because it may be easily removed by washing.

In this invention, the inorganic salt may be at least one selected from the group consisting of hydroacid salts, oxo acid salts, peroxo acid salts and halogen oxo acid salts.

Examples of hydroacid salts include hydrofluoric acid, hydrochloric acid, hydrobromic acid, hydroiodic acid, hydrogen sulfide, hydrocyanic acid, hydrazoic acid, chloroauric acid and chloroplatinic acid.

Examples of oxo acid salts include sulfates, nitrates, phosphates, carbonates, borates, uranates, chromates, tungstates, titanates and molybdates.

Examples of peroxo acid salts include peroxomonosulfates, peroxodisulfates, peroxonitrates, peroxomonophosphates, peroxodiphosphates, peroxomonocarbonates, peroxodicarbonates, peroxoborates, peroxouranates, peroxochromates, peroxotungstates, peroxotitanates and peroxomolybdates.

Examples of halogen oxo acid salts include perchlorates, perbromates and periodates.

A peroxo acid or halogen oxo acid salt is preferable because it acts as an oxidizing agent to chemically improve a polishing rate for the conductive metal film. In other words, it can be used as an alternative or adjuvant for an oxidizing agent added in a polishing slurry used in manufacturing a semiconductor device.

Among the above inorganic salts, preferable salts are ammonium and potassium salts and particularly preferable salts include potassium sulfate, ammonium sulfate, potassium chloride, potassium peroxodisulfate, ammonium peroxodisulfate and ammonium periodate.

Two or more of the above inorganic salts may be combined.

When preparing a semiconductor device using a polishing slurry of this invention, an inorganic salt preferably does not contain Na or a heavy metal. It is because Na may readily react with Si and therefore it tends to adhere and remain on an Si substrate even after washing, and a heavy metal tends to remain.

The content of the above inorganic salt used in this invention must be at least 0.01 wt %, preferably at least 0.05 wt % for improving a polishing rate for the tantalum metal film; and must be 10 wt % or less, preferably 5 wt % or less for preventing thixotropy in a polishing slurry. When combining two or more inorganic salts, the above content means their total.

A polishing slurry of this invention contains silica grains as a polishing grain and an inorganic salt, allowing us to significantly improve a polishing rate for the tantalum metal film while preventing scratches in a polished surface. Thus, the polishing rate for the tantalum metal film may be improved to reduce a difference in a polishing rate between the barrier metal film and the conductive metal film, so that dishing and erosion can be prevented without reducing a throughput and therefore, a good electric connection part may be formed.

It is believed that the inorganic salt used in this invention aggregates silica particles dispersed in water (flocculation) and the aggregated silica particles by the inorganic salt enhance mechanical polishing effect, resulting in good polishing of the tantalum metal film. The aggregation may be properly weak and relatively soft aggregated particles may be formed, so that a polishing rate for the tantalum metal film can be improved while preventing scratches in the polished surface.

In the light of a polishing rate and corrosion, a slurry viscosity and dispersion stability of a polishing grain, a polishing slurry of this invention has a pH of preferably at least 3, more preferably at least 4; and preferably 9 or less, more preferably 8 or less.

For the polishing slurry, pH may be adjusted by a known technique. For example, an alkali may be directly added to a slurry in which a silica polishing grain is dispersed and a carboxylic acid is dissolved. Alternatively, a part or all of an alkali to be added may be added as a carboxylic acid alkali salt. Examples of an alkali which may be used include alkali metal hydroxides such as potassium hydroxide; alkali metal carbonates such as potassium carbonate; ammonia; and amines.

An oxidizing agent may be added to a polishing slurry of this invention for enhancing polishing of a conductive metal film formed on a barrier metal film. The oxidizing agent may be appropriately selected from known water-soluble oxidizing agents in the light of a type of a conductive metal film, polishing accuracy and a polishing efficiency. For example, those which may not cause heavy-metal ion contamination include peroxides such as H₂O₂, Na₂O₂, Ba₂O₂ and (C₆H₅C)₂O₂; hypochlorous acid (HClO); perchloric acid; nitric acid; ozone water; and organic acid peroxides such as peracetic acid and nitrobenzene. Among these, hydrogen peroxide (H₂O₂) is preferable because it does not contain a metal component and does not generate a harmful byproduct. The content of the oxidizing agent in the polishing slurry of this invention is preferably at least 0.01 wt %, more preferably at least 0.05 wt % for achieving adequate effects of its addition; and preferably 15 wt % or less, more preferably 10 wt % or less for preventing dishing and adjusting a polishing rate to a proper value. When using an oxidizing agent which is relatively susceptible to deterioration with age such as hydrogen peroxide, it may be possible to separately prepare a solution containing an oxidizing agent at a given concentration and a composition which provides a given polishing slurry after addition of the solution containing an oxidizing agent, which are then combined just before use.

An organic acid such as a carboxylic acid and an amino acid may be added as a proton donor for enhancing oxidization by the oxidizing agent and achieving stable polishing.

Examples of a carboxylic acid include oxalic acid, malonic acid, tartaric acid, malic acid, glutaric acid, citric acid, maleic acid, formic acid, acetic acid, propionic acid, butyric acid, valeric acid, acrylic acid, lactic acid, succinic acid, nicotinic acid, their salts and a mixture thereof.

Among these carboxylic acids, those which may be used for further improving a polishing rate for a tantalum metal film are oxalic acid, malonic acid, tartaric acid, malic acid, glutaric acid, citric acid and maleic acid because they can also enhance flocculation of silica particles. Two or more of these carboxylic acids may be combined or they may be combined with another organic acid.

An amino acid may be added as a free form, as a salt or as a hydrate. Examples of those which may be added include arginine, arginine hydrochloride, arginine picrate, arginine flavianate, lysine, lysine hydrochloride, lysine dihydrochloride, lysine picrate, histidine, histidine hydrochloride, histidine dihydrochloride, glutamic acid, glutamic acid hydrochloride, sodium glutaminate monohydrate, glutamine, glutathione, glycylglycine, alanine, β-alanine, γ -aminobutyric acid, ε-aminocarproic acid, aspartic acid, aspartic acid monohydrate, potassium aspartate, potassium aspartate trihydrate, tryptophan, threonine, glycine, cystine, cysteine, cysteine hydrochloride monohydrate, oxyproline, isoleucine, leucine, methionine, ornithine hydrochloride, phenylalanine, phenylglycine, proline, serine, tyrosine, valine, and a mixture of these amino acids.

The content of the organic acid is preferably at least 0.01 wt %, more preferably at least 0.05 wt % to the total amount of the polishing slurry for achieving adequate effects of its addition; and preferably 5 wt % or less, more preferably 3 wt % or less for preventing dishing and adjusting a polishing rate to a proper value. When two or more organic acids are combined, the above content means the total amount of them.

When the organic acid is a polycarboxylic acid such as oxalic acid, malonic acid, tartaric acid, malic acid, glutaric acid, citric acid and maleic acid, its content is preferably 1 wt % or less, more preferably 0.8 wt % or less for inhibiting thixotropy in a polishing slurry. When two or more polycarboxylic acids are combined, the above content means the total amount of them.

When adding an oxidizing agent in a polishing slurry of this invention, an antioxidant may be further added. Addition of an antioxidant may allow a polishing rate for a conductive metal film to be easily adjusted and may result in forming a coating film over the surface of the conductive metal film to prevent dishing.

Examples of an antioxidant include benzotriazole, 1,2,4-triazole, benzofuroxan, 2,1,3-benzothiazole, o-phenylenediamine, m-phenylenediamine, cathechol, o-aminophenol, 2-mercaptobenzimidazole, 2-mercaptobenzoxazole, melamine, and their derivatives. Among these, benzotriazole and its derivatives are preferable. Examples of a benzotriazole derivative include substituted benzotriazoles having a benzene ring substituted with hydroxy; alkoxy such as methoxy and ethoxy; amino; nitro; alkyl such as methyl, ethyl and butyl; halogen such as fluorine, chlorine, bromine and iodine. Furthermore, naphthalenetriazole and naphthalenebistriazole as well as substituted naphthalenetriazoles and substituted naphthalenebistriazoles substituted as described above may be used.

The content of the antioxidant is preferably at least 0.0001 wt %, more preferably at least 0.001 wt % to the total amount of the polishing slurry for achieving adequate effects of its addition; and preferably 5 wt % or less, more preferably 2.5 wt % or less for adjusting a polishing rate to a proper value.

A polishing slurry of this invention may contain a variety of additives such as dispersing agents, buffers and viscosity modifiers commonly added to a polishing slurry as long as it does not deteriorate the properties of the slurry.

In a polishing slurry of this invention, a composition may be preferably adjusted to provide a polishing rate for a tantalum metal film of preferably at least 20 nm/min, more preferably at least 30 nm/min, further preferably at least 40 nm/min; and to provide a polishing rate for copper of preferably at least 30 nm/min, more preferably at least 40 nm/min, further preferably at least 50 nm/min. The composition of the polishing slurry of this invention may be preferably adjusted to provide a polishing rate ratio of the copper film to the tantalum metal film (Cu/Ta polishing ratio) of preferably 3/1 or less, more preferably 2/1 or less, further preferably 1.5/1 or less; and preferably at least 0.9/1, more preferably at least 1/1. The composition of the polishing slurry of this invention may be desirably adjusted to provide a higher polishing rate ratio of the tantalum metal film to the interlayer insulating film (Ta/insulating film polishing ratio) in a polishing slurry of this invention; preferably at least 10/1, more preferably at least 20/1, further preferably at least 30/1. There are no restrictions to its upper limit, but the composition may be adjusted to provide the ratio of preferably 100/1 or less, more preferably 200/1 or less.

A polishing slurry of this invention may be prepared by a common process for preparing a free grain polishing slurry. Specifically, polishing grain particles are added to a dispersion medium to an appropriate amount. A protective agent may be, if necessary, added to an appropriate amount. In such a state, air is strongly adsorbed in the surface of the grain particles, so that the grains are aggregated due to poor wettability. Thus, the aggregated polishing grain particles are dispersed into primary particles. In a dispersion process, a dispersion technique and a dispersion apparatus commonly used may be employed. Specifically, dispersion may be conducted using an apparatus such as an ultrasonic disperser, a variety of bead mill dispersers, a kneader and a ball mill by a known process. An inorganic salt may cause flocculation of silica particles while enhancing thixotropy. It is, therefore, preferable to add and mix the component after dispersion for achieving good dispersion.

CMP using a polishing slurry of this invention may be, for example, conducted as follows. A wafer in which, for example, an insulating film and a copper metal film are deposited on a substrate is placed on a spindle wafer carrier. The surface of the wafer is contacted with a polishing pad adhered on a rotary plate (surface plate). While supplying a polishing slurry to the surface of the polishing pad from a polishing slurry inlet, both the wafer and the polishing pad are rotated to polish the wafer. If necessary, a pad conditioner is contacted with the surface of the polishing pad to condition the surface of the polishing pad. The polishing slurry may be fed to the surface of the polishing pad from the side of the rotary plate.

The polishing slurry of this invention described above may be suitably applied to a process for forming an electric connection part such as a damascene interconnect, a via plug and a contact plug by CMP of a substrate where a tantalum metal film as a barrier metal film is formed on an insulating film having a concave such as a trench and a connection hole and a conductive metal film is formed over the whole surface such that the concave is filled with the metal, until the surface of the insulating film is substantially completely exposed. Examples of an insulating film include a silicon oxide film, a BPSG film and an SOG film. A conductive metal film may be made of, for example, copper, silver, gold, platinum, titanium, tungsten, aluminum or an alloy thereof. In particular, the polishing slurry of this invention may be suitable used when a conductive metal film is a copper-containing film such as a copper film or a copper alloy film mainly containing copper.

This invention will be more specifically described with reference to Examples.

### EXAMPLES 1 to 8

A polishing slurry with pH4.5 was prepared, which comprises 5 wt % of fumed silica Qs-9 (Tokuyama) and 0.1 to 3 wt % of potassium sulfate (Kanto Chemical). Using the polishing slurry, CMP was conducted for a substrate on which were sequentially deposited a silicon oxide film with a thickness of 500 nm, a tantalum film with a thickness of 50 nm and a copper film with a thickness of 50 nm.

As Comparative Example 1, a polishing slurry was prepared as described in Examples 1 to 8, omitting potassium sulfate. Using the polishing slurry, CMP was conducted for a substrate on which were sequentially deposited a silicon oxide film with a thickness of 500 nm, a tantalum film with a thickness of 50 nm and a copper film with a thickness of 50 nm.

CMP was conducted using a Speedfam-Ipec Type SH-24 apparatus. The polisher was used, on whose surface plate a polishing pad (Rodel-Nitta IC 1400) was attached. Polishing conditions were as follows: a polishing load(a contact pressure of the polishing pad): 27.6 kPa; a rotating speed of the surface plate: 55 rpm; a carrier rotating speed: 55 rpm; and a polishing slurry feeding rate: 100 mL/min.

Polishing rates for copper and tantalum were determined as follows. Four needle electrodes were aligned on a wafer with a given interval. A given current was applied between the outer two probes to detect a potential difference between two inner probes for determining a resistance (R′) and further the value is multiplied by a correction factor RCF (Resistivity Correction Factor) to a surface resistivity (ρs′). A surface resistivity (ρs) is determined for a wafer film whose thickness (T) (nm) is known. The surface resistivity is inversely proportional to the thickness. Thus, when a thickness for a surface resistivity of ρ′s is d, an equation d(nm)=(ρs×T)/ρ′s holds true. Using the equation, the thickness d can be determined. Furthermore, a variation between before and after polishing was divided by a polishing time to estimate a polishing rate. A surface resistivity was determined using Mitsubishi Chemical Industries Four Probe Resistance Detector (Loresta-GP).

The results are shown in Table 1. As seen in Table 1, addition of potassium sulfate considerably increased the polishing rate for the tantalum film without reduction in the polishing rate for the copper film and increase in the amount (content) of potassium sulfate increased the polishing rate for tantalum.

Furthermore, the appearance of the polishing slurry was changed by adding glutaric acid from translucent to cloudy. This indicated that a scattering intensity increased due to particles with a large size by aggregation. From the results it is suspected that addition of an inorganic salt caused increase in an ion strength in the solution, which pressed an electric double layer, leading to reduction in an electric repulsion between fumed silica particles while aggregation (flocculation) occurred due to interaction between the inorganic salt and the silica particle, and properly soft silica aggregates formed by the aggregation acted as polishing grains to enhance mechanical polishing and thus to improve the polishing rate of the tantalum film.

TABLE 1

| | Potassium sulfate | Ta polishing rate | Cu polishing rate |
|---|---|---|---|
| | (wt %) | (nm/min) | (nm/min) |
| Comp. | 0 | 25.7 | 8.1 |
| Example 1 | | | |
| Example 1 | 0.10 | 32.1 | Not determined |
| Example 2 | 0.25 | 39.9 | Not determined |
| Example 3 | 0.50 | 50.3 | Not determined |
| Example 4 | 0.75 | 58.5 | Not determined |
| Example 5 | 1.00 | 67.2 | 9.8 |
| Example 6 | 2.00 | 97.1 | Not determined |
| Example 7 | 2.50 | 105.1 | Not determined |
| Example 8 | 3.00 | 109.2 | 11.8 |

### EXAMPLES 9 and 10

A polishing slurry was prepared as described in Examples 5 or 8, replacing potassium sulfate with ammonium sulfate or potassium chloride to determine a polishing rate.

As seen in Table 2, a polishing rate for tantalum was increased when adding an inorganic salt other than potassium sulfate, i.e., ammonium sulfate or potassium chloride.

TABLE 2

| | | Conc. of an | Ta polishing | |
|---|---|---|---|---|
| | | inorganic | rate | Cu polishing |
| | Inorganic salt | salt (wt %) | (nm/min) | rate (nm/min) |
| Example | ammonium | 1.0 | 59.1 | 9.6 |
| 9 | sulfate | | | |
| Example | potassium | 3.0 | 102.1 | 11.1 |
| 10 | chloride | | | |

### EXAMPLES 11 to 16

Polishing slurries were prepared, replacing potassium sulfate with a variety of oxidizing inorganic salts indicated in Table 3, respectively, to determine a polishing rate as described in Examples 3, 5 and 6. For comparison, in Example 16, a polishing slurry was prepared, which comprised potassium sulfate which was a non-oxidizing inorganic salt and 2.5 wt % of hydrogen peroxide. Table 3 again includes the results in Example 5 for comparison.

As seen in Table 3, a polishing rate for tantalum was also increased by adding an oxidizing inorganic salt. In addition, oxidation by the inorganic salt considerably increased a polishing rate for copper in comparison with Example 5. Compared with Example 16, it was observed that by adding the oxidizing inorganic salt, a polishing rate for copper increased to a similar level to addition of hydrogen peroxide.

TABLE 3

| | | Conc. of an | Hydrogen | Ta polishing | Cu polishing |
|---|---|---|---|---|---|
| | | inorganic | Peroxide | rate | rate |
| | Inorganic salt | salt (wt %) | (wt %) | (nm/min) | (nm/min) |
| Example 11 | Potassium peroxodisulfate | 0.5 | 0 | 50.5 | 247.8 |
| Example 12 | Potassium peroxodisulfate | 1.0 | 0 | 71.2 | 468.6 |
| Example 13 | Potassium peroxodisulfate | 2.0 | 0 | 79.8 | 623.2 |
| Example 14 | Ammonium peroxodisulfate | 1.0 | 0 | 68.3 | 480.3 |
| Example 15 | Ammonium periodate | 1.0 | 0 | 69.5 | 470.0 |
| Example 16 | Potassium sulfate | 1.0 | 2.5 | 70.8 | 472.2 |
| Example 5 | Potassium sulfate | 1.0 | 0 | 67.2 | 9.8 |

### EXAMPLES 17 to 20

A polishing slurry of this invention was prepared and using it, CMP was conducted to form a copper damascene interconnect using a tantalum film as a barrier metal film.

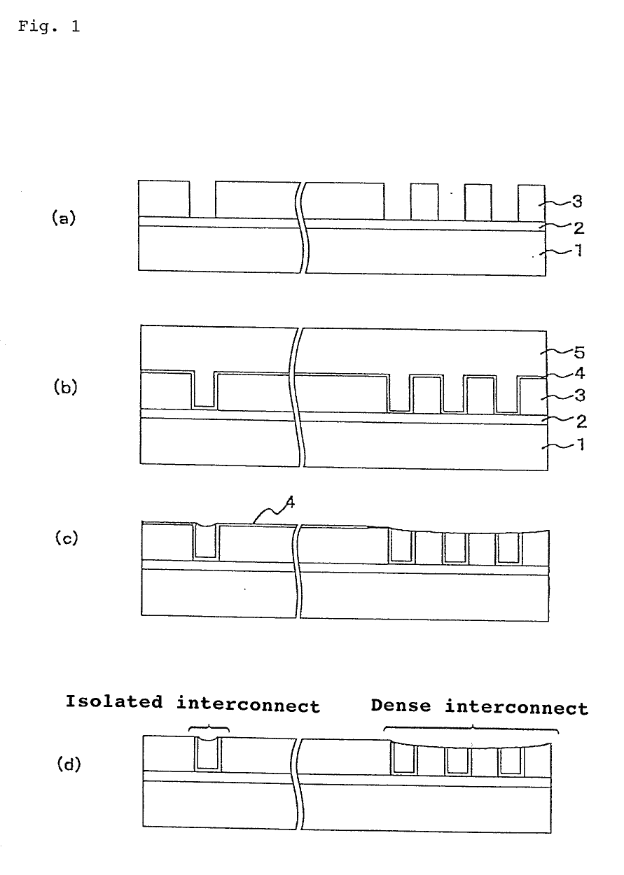

On a 6 inch wafer (silicon substrate, not shown) in which a semiconductor device such as a transistor was formed was deposited a lower interconnect layer 1 made of a silicon oxide film comprising a lower interconnect (not shown). On the lower interconnect layer was, as shown in FIG. 1(a), formed a silicon nitride film 2, on which was formed a silicon oxide film 3 with a thickness of about 500 nm. The silicon oxide film 3 was patterned by photolithography and reactive ion etching as usual to form a trench for interconnection and a connection hole with a width of 0.23 to 10 μm and a depth of 500 nm. Then, as shown in FIG. 1(b), Ta film 4 was formed to a thickness of 50 nm by sputtering, a Cu film was formed to a thickness of about 50 nm by sputtering, and then a copper film 5 was formed to a thickness of about 800 nm by plating.

For CMP of the substrate thus prepared, a polishing slurry was prepared, which comprised potassium sulfate, hydrogen peroxide (Kanto Chemical), oxalic acid or malic acid (Kanto Chemical) and benzotriazole (Kanto Chemical).

Table 4 indicates that concentrations of the organic acid or the oxidizing agent may be varied to adjust a polishing rate for copper while keeping a polishing rate for tantalum constant, i.e., a polishing rate ratio of copper/tantalum may be controlled while keeping a polishing rate for tantalum constant. Observation of the cross section of the substrate by SEM indicated that there were no significant scratches and that dishing and erosion were prevented.

TABLE 4

| | Potassium | Hydrogen | | Conc. of | Benzo- | Ta polishing | Cu polishing |
|---|---|---|---|---|---|---|---|
| | sulfate | Peroxide | Organic | an Organic | triazole | rate | rate |
| | (wt %) | (wt %) | acid | acid (wt %) | (wt %) | (nm/min) | (nm/min) |
| Example 17 | 1.0 | 2.5 | Oxalic acid | 0.1 | 0.001 | 65.2 | 29.8 |
| Example 18 | 1.0 | 2.5 | Malic acid | 0.02 | 0.005 | 64.0 | 38.1 |
| Example 19 | 1.0 | 2.5 | Malic acid | 0.03 | 0.005 | 64.3 | 65.2 |
| Example 20 | 1.0 | 2.5 | Malic acid | 0.04 | 0.005 | 64.7 | 100.5 |

### EXAMPLES 21 and 22

The polishing slurries in Table 5 were prepared, which was then used in CMP to form a copper damascene interconnect.

The results of Example 21 and 22 indicate that a polishing rate for copper was reduced while a polishing rate for tantalum was kept constant, by partially replacing potassium peroxodisulfate with potassium sulfate. It indicates that an appropriate combination of inorganic salts may permit us to adjust the polishing rate ratio without using an oxidizing agent.

These results indicate that the polishing slurries in Examples 17 to 22 can be used in CMP for forming a copper damascene interconnect and a contact to achieve a higher polishing rate for tantalum, an adequate polishing rate for copper, a good polishing rate ratio of copper/tantalum and a lower polishing rate for a silicon oxide film, which consequently led to a higher throughput, inhibition of dishing and erosion, inhibition of a recess in an isolated interconnect area and a good shape of pattern cross section. The results show that a properly small polishing rate ratio between copper and tantalum prevented excessive polishing of the copper film and the insulating film had a polishing rate adequately low to act as a stopper for preventing dishing and erosion.

TABLE 5

| | | Potassium | | | | | Ta | Cu |
|---|---|---|---|---|---|---|---|---|
| | Potassium | Peroxodi- | Hydrogen | | Conc. of | Benzo- | polishing | polishing |
| | sulfate | sulfate | peroxide | Organic | an organic | triazole | rate | rate |
| | (wt %) | (wt %) | (wt %) | acid | acid (wt %) | (wt %) | (nm/min) | (nm/min) |
| Example 21 | 0 | 0.5 | 0 | Malic acid | 0.15 | 0.005 | 47.5 | 128.3 |
| Example 22 | 0.25 | 0.25 | 0 | Malic acid | 0.15 | 0.005 | 48.1 | 71.2 |

What is claimed is:

1. A slurry for chemical mechanical polishing for polishing a substrate comprising an insulating film and a tantalum-containing metal film on the insulating film, comprising a silica polishing grain, and an inorganic salt in an amount of 0.01 wt % to 10 wt % both inclusive to a total amount of the slurry for chemical mechanical polishing.

2. A slurry for chemical mechanical polishing as claimed in claim 1, wherein the inorganic salt is at least one selected from the group consisting of hydroacid salts, oxo acid salts, peroxo acid salts and halogen oxo acid salts.

3. A slurry for chemical mechanical polishing as claimed in claim 1, wherein the inorganic salt is at least one selected from the group consisting of salts containing ammonium ion, salts containing alkali metal ion, salts containing alkali-earth metal ion, salts containing group III metal ion, salts containing group IV metal ion, salts containing group V metal ion and salts containing transition metal ion.

4. A slurry for chemical mechanical polishing as claimed in claim 1, wherein the silica polishing grain is made of fumed silica.

5. A slurry for chemical mechanical polishing as claimed in claim 1, wherein the content of the silica polishing grain is 1 wt % to 30 wt % both inclusive to a total amount of the slurry for chemical mechanical polishing.

6. A slurry for chemical mechanical polishing as claimed in claim 1, comprising an organic acid in an amount of 0.01 wt % to 5 wt % both inclusive to a total amount of the slurry for chemical mechanical polishing.

7. A slurry for chemical mechanical polishing as claimed in claim 1, comprising at least one selected from the group consisting of oxalic acid, malonic acid, tartaric acid, malic acid, glutaric acid, citric acid and maleic acid in an amount of 0.01 wt % to 1 wt % both inclusive to a total amount of the slurry for chemical mechanical polishing.

8. A slurry for chemical mechanical polishing as claimed in claim 1, wherein pH is 3 to 9 both inclusive.

9. A slurry for chemical mechanical polishing as claimed in claim 1, wherein the substrate comprises
the insulating film having a concave,
the tantalum-containing metal film as a barrier metal film formed on the insulating film and
a conductive metal formed such that the concave is filled with the conductive metal.

10. A slurry for chemical mechanical polishing as claimed in claim 9, wherein the conductive metal film is a copper film or a copper alloy film.

11. A slurry for chemical mechanical polishing as claimed in claim 1, comprising an oxidizing agent in an amount of 0.01 wt % to 15 wt % both inclusive to a total amount of the slurry for chemical mechanical polishing.

12. A slurry for chemical mechanical polishing as claimed in claim 1, comprising an antioxidant in an amount of 0.0001 wt % to 5 wt % both inclusive to a total amount of the slurry for chemical mechanical polishing.
